(19) United States
(12) Patent Application Publication
(10) Pub. No.: US 2005/0011241 A1
(43) Pub. Date: Jan. 20, 2005

(54) Burglary prevention device

(76) Inventor: Barbara Jo Underdahl, Ham Lake, MN (US)

Correspondence Address: Michael A. Kondzella, Suite 112, 10650 County Road 81, Maple Grove, MN, 55369, US

(21) Appl. No.: 10/622,503

(22) Filed: Jul. 18, 2003

(51) Int. Cl. E05B 15/00; E05B 17/00; E05B 63/00

(52) U.S. Cl. 70/418; 292/346

(57) ABSTRACT

A burglary prevention device is in the form of a T-shaped metal plate having a major portion with a plurality of holes and a minor portion constituting a tang. The device can be installed in any doorway in which a deadbolt is used. It is installed so that the tang of the device is fitted into the latchbolt hole into which the deadbolt fits in the locked position and is positioned immediately in front of the deadbolt.

### FIELD OF THE INVENTION

This invention relates to home security. In one of its more particular aspects the present invention relates to a device for protecting homes and other buildings against burglaries. In another of its more particular aspects this invention relates to enhancing the security of door locks. More particularly, this invention relates to a device which increases the effectiveness of deadbolts.

### BACKGROUND OF THE INVENTION

A wide variety of methods for safeguarding the security of homes, apartments, and business offices have been devised. Door locks including deadbolts have been somewhat effective in preventing entry by burglars and other unwanted intruders. However, doors fitted with deadbolts can be pried open or kicked in.

It is an object of the present invention to increase the security provided by a deadbolt.

Another object of this invention is to provide a means for reinforcing a deadbolt.

Another object is to provide an easily installable device which will greatly increase the effectiveness of a deadbolt.

Other objects and advantages of the present invention will become apparent from the following detailed disclosure and description.

### SUMMARY OF THE INVENTION

The present invention provides a way for increasing the effectiveness of a deadbolt, which utilizes a device that can be easily installed in existing doorways, so that it is out of sight and will not hinder an emergency escape plan.

The burglary prevention device of the present invention comprises a rigid, flat, substantially T-shaped metal plate having a plurality of holes in the major portion of the plate. The minor portion of the plate constitutes a tang, which is perpendicular to the major portion of the plate and integral therewith.

The device of this invention can be installed on the housing frame of any doorway under the finishing trim of the doorway. It is installed so that the tang of the device is fitted into the latchbolt hole into which the deadbolt fits in the locked position and is positioned immediately in front of the deadbolt.

With the burglary prevention device of the present invention installed, the shear strength of the doorjamb is increased up to 20 times. The resulting increased compressive strength of the door frame makes it virtually impossible to spread the door from its frame so as to disengage the deadbolt.

### BRIEF DESCRIPTION OF THE DRAWINGS

FIG. 1 is a perspective view of the burglary prevention device of the present invention.

FIG. 2 is a front elevation, partly in phantom, of a door equipped with a deadbolt and fitted with the burglary prevention device of this invention.

FIG. 3 is a detailed enlargement of that portion of FIG. 2 shown within the broken line circle with only the deadbolt shown in phantom.

FIG. 4 is a side elevation of a portion of a doorjamb showing the deadbolt and burglary prevention device of the present invention.

### DESCRIPTION OF THE PREFERRED EMBODIMENTS

A preferred embodiment of the present invention will now be described with reference to the drawings.

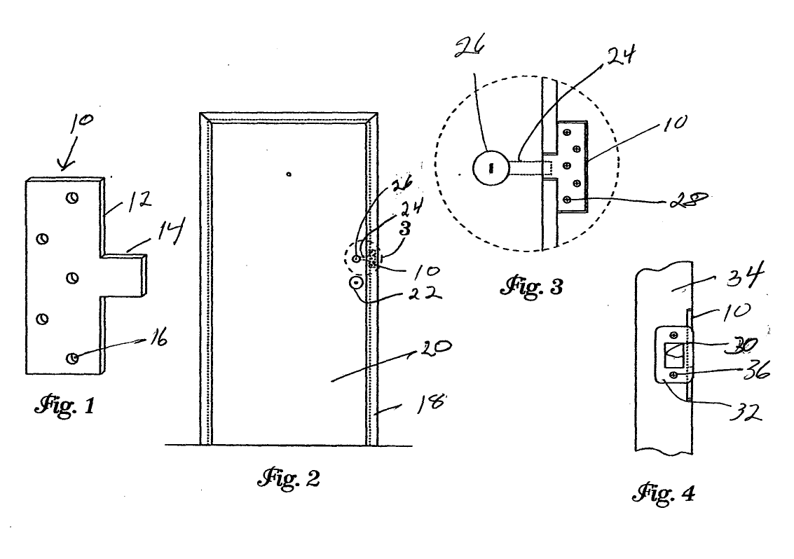

Referring to FIG. 1, the numeral 10 designates the burglary prevention device of the present invention, which includes a major portion 12 and a tang 14, which constitutes a minor portion of burglary prevention device 10. Major portion 12 contains a plurality of holes 16, five being shown in FIG. 1.

FIG. 2 shows burglary prevention device 10 installed behind the finishing trim 18 adjacent a door 20 equipped with a doorknob 22, a deadbolt 24, and a deadbolt control 26. Details of the arrangement of deadbolt 24 and burglary prevention device 10 are shown in FIG. 3, which also shows screws 28 used to attach burglary prevention device 10.

FIG. 4 shows the arrangement of burglary prevention device 10 with respect to the latchbolt opening 30 in latchbolt plate 32, which is attached to doorjamb 34 by means of screws 36.

The burglary prevention device of the present invention can be fabricated from steel or a comparable strong metal. In a preferred embodiment the device is a ⅛ inch stainless steel plate having five countersunk ¼ inch holes in a staggered arrangement. The dimensions of the major portion are 3¾ inches by 1⅜ inches with the tang being disposed 1½ inches from either end of the major portion. Each of the five holes is ¼ inch in diameter with no hole having its center less than 5/16 inch from an edge of the device. In a particularly preferred embodiment as shown in FIG. 1 the centers of the two holes on the left, which are aligned vertically, are 1 9/16 inches apart and the centers of each of the top and bottom holes on the right, are 1 9/16 inches from the center of the middle hole, all of the holes on the right being vertically aligned.

In general the vertical dimension of the tang approximates the diameter of the deadbolt and its horizontal dimension approximates the length of the deadbolt which extends into the doorjamb.

It will be appreciated that the disclosure and description in the instant specification are set forth by way of illustration and not limitation, and that various modifications and changes may be made without departing from the spirit and scope of the present invention, which are defined in the claims appended hereto.

1 A burglary prevention device comprising a rigid, flat, substantially T-shaped metal plate adapted for installation on the housing frame of a doorway under the finishing trim thereof, said plate having a tang integral therewith and adapted for positioning adjacent a deadbolt in the locked position.

2 The burglary prevention device of claim 1, wherein said metal plate is fabricated of stainless steel.

3 The burglary prevention device of claim 1, wherein said metal plate has a plurality of holes in the portion of the plate which does not include such tang.

4 The burglary prevention device of claim 3, wherein said holes are countersunk.

5 The burglary prevention device of claim 3, wherein said plurality of holes is staggered.

6 The burglary prevention device of claim 3, wherein said plurality of holes numbers five.

7 The burglary prevention device of claim 6, wherein said five holes are disposed in two side-by-side vertical columns of two holes and three holes, respectively.

8 The burglary prevention device of claim 3, wherein none of said plurality of holes has its center less than about 5/16 inch from any edge of said plate.

9 The burglary prevention device of claim 1, wherein said metal plate is at least about ⅛ inch thick.

10 The burglary prevention device of claim 1, wherein the vertical dimension of said tang approximates the diameter of said deadbolt.

11 The burglary prevention device of claim 1, wherein the horizontal dimension of said tang approximates the length of said deadbolt which extends into the doorjamb of said doorway in the locked position.

12 A burglary prevention device comprising a rigid, flat, substantially T-shaped metal plate adapted for installation on the housing frame of a doorway under the finishing trim thereof, said plate having a tang, which is perpendicular to the major portion of the plate and integral therewith, said tang being adapted for positioning adjacent a deadbolt in the locked position.
